(19) United States
(12) Patent Application Publication
(10) Pub. No.: US 2026/0185542 A1
(43) Pub. Date: Jul. 2, 2026

(54) REFRIGERANT COMPRESSOR INCLUDING RESONATOR

(71) Applicant: Danfoss A/S, Nordborg (DK)

(72) Inventors: Jin Yan, Tallahassee, FL (US); Brenden Richman, Tallahassee, FL (US); Lin Xiang Sun, Tallahassee, FL (US); Frank Ford, Tallahassee, FL (US)

(21) Appl. No.: 19/129,055

(22) PCT Filed: Apr. 15, 2024
(86) PCT No.: PCT/US24/24557

§ 371 Date: May 12, 2025

Related U.S. Application Data
(60) Provisional application No. 63/459,734, filed on Apr. 17, 2023.

(51) Int. Cl. F04D 29/66; F04D 17/10; F25B 31/00

(52) U.S. Cl. CPC F04D 29/665; F04D 17/10; F25B 31/00; F25B 2500/12

(57) ABSTRACT

This disclosure relates generally to refrigerant compressors, and more particularly to a resonator for a refrigerant compressor. The resonator is arranged adjacent, or downstream of, an outlet of the refrigerant compressor. The assemblies, systems, and methods disclosed herein have been found to attenuate noise.

### RELATED APPLICATION(S)

This application claims the benefit of International Application No. PCT/US24/24557, filed Apr. 15, 2024 which claims priority to U.S. Provisional Application No. 63/459,734, filed Apr. 17, 2023, the entirety of which is herein incorporated by reference.

### BACKGROUND

Refrigerant compressors are used to circulate refrigerant in a chiller via a refrigerant loop. Refrigerant loops are known to include a compressor, a condenser, an expansion device, and an evaporator. The compressor compresses the fluid, which then travels to the condenser, which in turn cools and condenses the fluid. The refrigerant then goes to the expansion device, which decreases the pressure of the fluid, and to the evaporator, where the fluid is vaporized, completing a refrigeration cycle.

### SUMMARY

In some aspects, the techniques described herein relate to a refrigerant compressor, including: a resonator configured to attenuate noise, wherein the resonator is arranged adjacent, or downstream of, an outlet of the refrigerant compressor.

In some aspects, the techniques described herein relate to a refrigerant compressor, wherein the resonator is integrally formed into a housing of the compressor.

In some aspects, the techniques described herein relate to a refrigerant compressor, wherein the resonator is located adjacent, or immediately downstream, of an outlet volute of the compressor.

In some aspects, the techniques described herein relate to a refrigerant compressor, wherein the resonator includes a plurality of grooves spaced-apart from one another along a central axis of a flow path radially inward of the plurality of grooves.

In some aspects, the techniques described herein relate to a refrigerant compressor, wherein the resonator includes an inner section arranged radially inward of an outer section.

In some aspects, the techniques described herein relate to a refrigerant compressor, wherein the plurality of grooves are formed in the outer section.

In some aspects, the techniques described herein relate to a refrigerant compressor, wherein the inner section includes a ring spaced-apart radially inward of the outer section, and wherein the inner section further includes a cone spaced-apart radially inward of the ring.

In some aspects, the techniques described herein relate to a refrigerant compressor, wherein a plurality of additional grooves are formed in a radially inner surface of the ring.

In some aspects, the techniques described herein relate to a refrigerant compressor, wherein a radial dimension of the cone increases moving toward the outlet of the refrigerant compressor.

In some aspects, the techniques described herein relate to a refrigerant compressor, wherein each of the plurality of grooves is rectangular in cross-sectional shape.

In some aspects, the techniques described herein relate to a refrigerant compressor, wherein each of the plurality of grooves exhibits a unique depth relative to the others of the plurality of grooves.

In some aspects, the techniques described herein relate to a refrigerant compressor, wherein each of the plurality of grooves exhibits an incrementally increasing depth moving toward the outlet of the refrigerant compressor.

In some aspects, the techniques described herein relate to a refrigerant compressor, wherein: a first groove of the plurality of grooves a depth within a range of 2.5-3.5 mm and is configured to attenuate noise having a frequency of about 7,500 Hz, a second groove of the plurality of grooves exhibits a depth within a range of 3.6-4.9 mm and is configured to attenuate noise having a frequency of about 6,000 Hz, a third groove of the plurality of grooves exhibits a depth within a range of 5.0-6.5 mm and is configured to attenuate noise having a frequency of about 5,000 Hz, and a fourth groove of the plurality of grooves exhibits a depth within a range of 6.6-8.5 mm and is configured to attenuate noise having a frequency of about 3,500 Hz.

In some aspects, the techniques described herein relate to a refrigerant compressor, wherein the resonator is formed as a separate structure from a housing of the refrigerant compressor, wherein the separate structure is configured to fit within a recess of the housing.

In some aspects, the techniques described herein relate to a refrigerant compressor, wherein: the resonator is formed as a separate structure from a housing of the refrigerant compressor, and the separate structure includes a plate configured to attach to a housing of the refrigerant compressor.

In some aspects, the techniques described herein relate to a refrigerant compressor, wherein: the resonator is formed as a separate structure from a housing of the refrigerant compressor, and the separate structure includes a plate configured to attach to a pipe downstream of the refrigerant compressor.

In some aspects, the techniques described herein relate to a refrigerant system, including: a compressor, a condenser, an evaporator, and an expansion device, wherein the compressor includes: a resonator configured to attenuate noise, wherein the resonator is arranged adjacent, or downstream of, an outlet of the refrigerant compressor.

In some aspects, the techniques described herein relate to a refrigerant system, wherein the resonator includes a plurality of grooves spaced-apart from one another along a central axis of a flow path radially inward of the plurality of grooves.

In some aspects, the techniques described herein relate to a refrigerant system, wherein: the resonator includes an inner section arranged radially inward of an outer section, the plurality of grooves are formed in the outer section, the inner section includes a ring spaced-apart radially inward of the outer section, and the inner section further includes a cone spaced-apart radially inward of the ring.

In some aspects, the techniques described herein relate to a refrigerant system, wherein each of the plurality of grooves exhibits an incrementally increasing depth moving toward the outlet of the refrigerant compressor.

### BRIEF DESCRIPTION OF THE DRAWINGS

FIG. 1 schematically illustrates a refrigerant system.

FIG. 2 is a schematic, partial cross-sectional view of a compressor.

FIG. 3 is a perspective view of a first example resonator, viewed from a perspective of an exterior of the compressor.

FIG. 4 is a cross-sectional view of a portion of the compressor, and illustrates the first example resonator.

FIG. 5 is a perspective view of a second example resonator.

FIG. 6 is a cross-sectional view of the second example resonator and a portion of the compressor, with the second example resonator spaced-apart from the compressor.

FIG. 7 is a cross-sectional view of the second example resonator and a portion of the compressor, with the second example resonator received in a recess of the compressor.

FIG. 8 is a perspective view of a third example resonator.

FIG. 9 is a perspective view of the third example resonator attached to the compressor housing.

FIG. 10 is a cross-sectional view of a portion of the compressor and the third example resonator.

FIG. 11 is a perspective view of the third example resonator mounted relative to a first pipe section and a second pipe section.

FIG. 12 is a cross-sectional view the third example resonator, the first pipe section, and the second pipe section.

FIG. 13 is a cross-sectional view of a portion of the compressor and a fourth example resonator.

### DETAILED DESCRIPTION

This disclosure relates generally to refrigerant compressors, and more particularly to a resonator for a refrigerant compressor. The assemblies, systems, and methods disclosed herein have been found to attenuate noise.

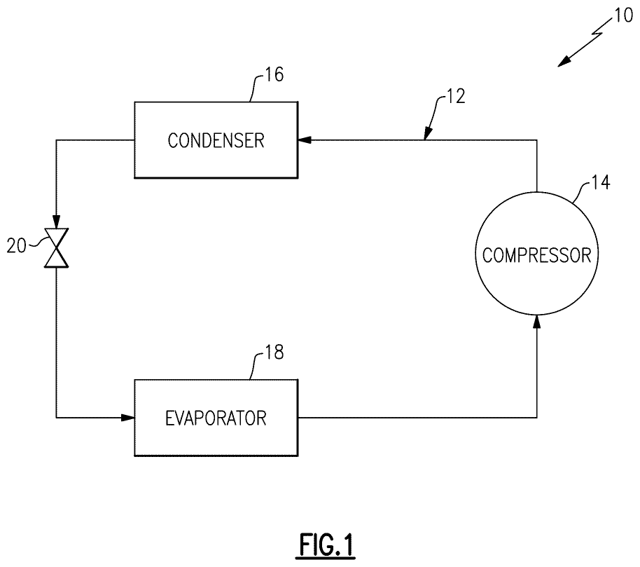

FIG. 1 illustrates a refrigerant system 10. The refrigerant system 10 includes a main refrigerant loop, or circuit, 12 in communication with a compressor 14, a condenser 16, an evaporator 18, and an expansion device 20. This refrigerant system 10 may be used in a chiller, for example. In that example, a cooling tower may be in fluid communication with the condenser 16. While a particular example of the refrigerant system 10 is shown, this application extends to other refrigerant system configurations, including configurations that do not include a chiller. For instance, the main refrigerant loop 12 can include an economizer downstream of the condenser 16 and upstream of the expansion device 20.

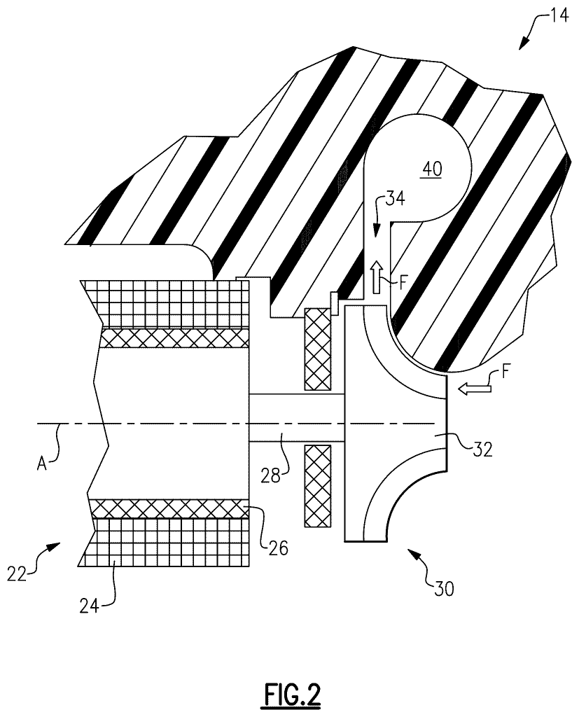

FIG. 2 illustrates, in cross-section, a portion of an example compressor 14. The compressor 14 includes an electric motor 22 having a stator 24 arranged radially outside of a rotor 26. The rotor 26 is connected to a shaft 28, which rotates to drive at least one compression stage 30 of the compressor 14, which in this example includes at least one impeller 32. The compressor 14 may include multiple compression stages.

The shaft 28 and impeller 32 are rotatable by the electric motor 22 about an axis A to compress refrigerant F. The terms axial, radial, and circumferential in this disclosure are used relative to the axis A. The shaft 28 may be rotatably supported by a plurality of bearing assemblies, which in some examples are magnetic bearing assemblies.

During operation of the compressor 14, refrigerant F flows axially toward the impeller 32 and is expelled radially outwardly to a diffuser 34 downstream of the impeller 32. The diffuser 34 is arranged radially between the outlet of the impeller 32 and a volute 40. The volute 40 may be in fluid communication with the condenser 16 or another compression stage of the compressor 14.

In this disclosure, the compressor 14 includes a resonator configured to attenuate noise. In particular, the compressor 14 includes a resonator configured to attenuate noises of certain frequencies, which correspond to known noise frequencies associated with operation of the compressor 14. As will be discussed below, the resonator is provided adjacent, or downstream, of the outlet of the compressor 14, and may be integrally formed (i.e., machined into) a housing of the compressor 14, or provided as a separate component, among other embodiments.

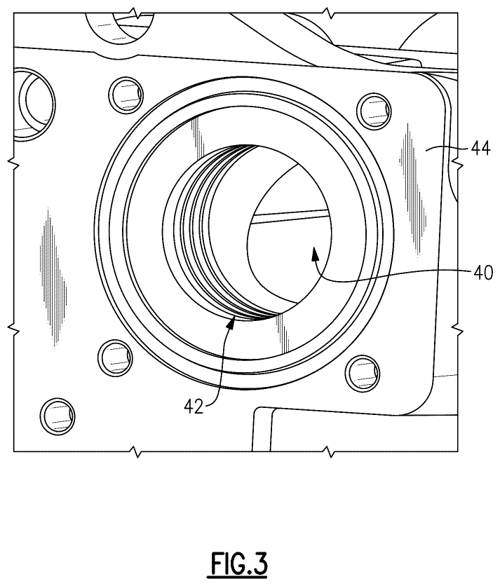

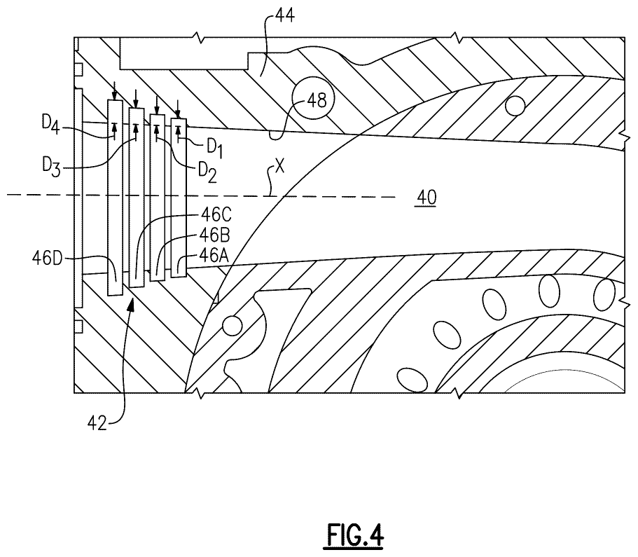

With reference to FIGS. 3 and 4, a first example resonator 42 is shown. The resonator 42 is integrally formed into a housing 44 of the compressor 14 at a location adjacent, and immediately downstream, of the volute 40. The housing 44 may be coupled to a pipe downstream of the resonator 42, which pipe may lead directly to the condenser 16. While shown separate from the volute 40, the housing 44 and volute 40 could be integrally formed. The portion of the housing 44 that is shown defines an outlet of the compressor 14.

The resonator 42, in this example, includes grooves 46A-46D. While four grooves 46A-46D are shown, the resonator 42 could include one or more grooves. In this example, the grooves 46A-46D extend continuously about a circumference of an axis X, which is a central axis of a flow path radially inward of the grooves 46A-46D. Further, the grooves 46A-46D are axially spaced-apart from one another along the axis X. The grooves 46A-46D are machined-into a radially inner surface 48 of the housing 44, in this example. The radially inner surface 48 provides a radially outer boundary of a flow path of fluid F expelled from the volute 40, in this example.

Each of the grooves 46A-46D is configured to attenuate noise of a different frequency. In particular, each of the grooves 46A-46D exhibits a unique depth relative to the other grooves 46A-46D, and the depth of each groove 46A-46D corresponds to the frequency of noise that the groove is configured to attenuate. As fluid passes through the resonator 42, some of that fluid enters grooves 46A-46D, and the sound waves inside the grooves 46A-46D interfere with the incoming sound waves from the fluid flow, leading to destructive interference and a reduction in the overall amplitude of the sound waves. The resonator 42 may be referred to as a noise attenuator.

In this example, the grooves 46A-46D exhibit depths D₁-D₄, respectively, measured radially, beginning from the radially inner surface 48 of the housing 44 at a location immediately adjacent a respective groove, in a direction perpendicular to axis X. Each of the grooves 46A-46D exhibits a rectangular cross-sectional shape, in this example.

The grooves 46A-46D increase incrementally in depth D₁-D₄ moving from the volute 40 toward the outlet of the compressor 14, in this example. In other examples, the depths do not follow an incrementally increasing sequence.

In a particular example, the groove 46A exhibits a depth D₁ within a range of 2.5-3.5 mm, which is configured to attenuate noise having a frequency of about 7,500 Hz. Further, the groove 46B exhibits a depth D₂ within a range of 3.6-4.9 mm, which is configured to attenuate noise having a frequency of about 6,000 Hz. Additionally, groove 46C exhibits a depth D₃ within a range of 5.0-6.5 mm, which is configured to attenuate noise having a frequency of about 5,000 Hz. Finally, in this example, groove 46D exhibits a depth D₄ within a range of 6.6-8.5 mm, which is configured to attenuate noise having a frequency of about 3,500 Hz.

While the above dimensions and target noise frequencies are exemplary, providing grooves 46A-46D with the above-mentioned dimensions targets attenuation of a relatively wide range of noise frequencies known to occur in certain centrifugal refrigerant compressors. In particular, the range of noise frequencies targeted by the above-discussed arrangement corresponds to the noises generated based on the speeds, capacity, etc., corresponding to centrifugal refrigerant compressors, as opposed to other types of compressors, such as those associated with turbochargers, which operate at significantly higher speeds, among other differences.

Three additional resonators 142, 242, 342 will now be described. The resonators 142, 242, 342 include like components, including a like groove arrangement, relative to resonator 42, except where described below.

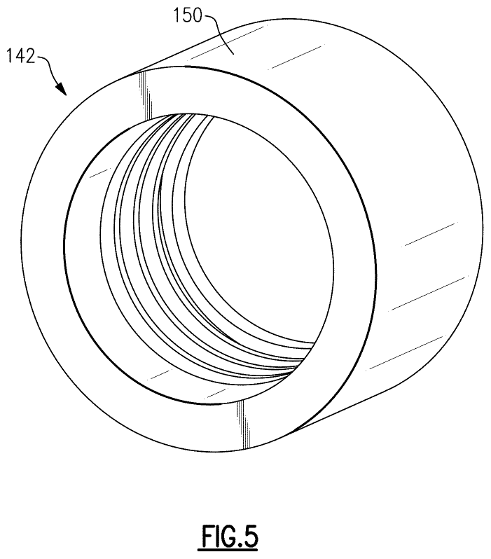

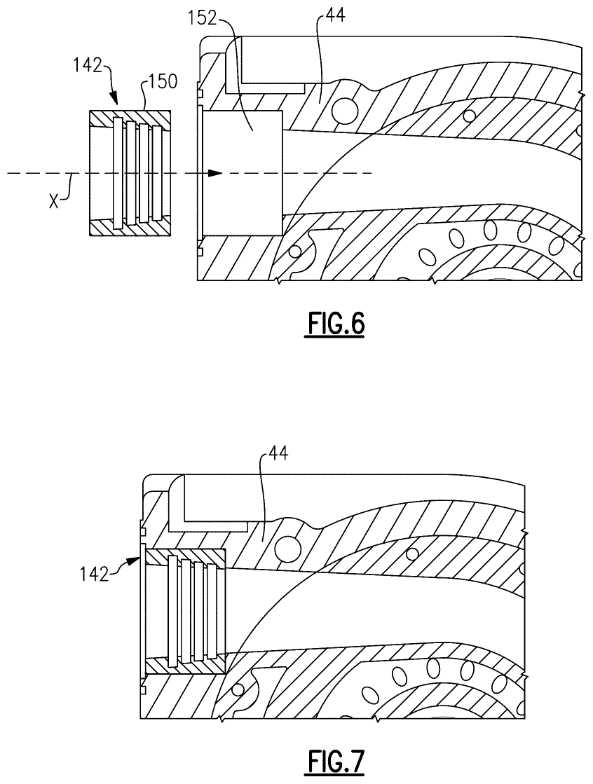

FIGS. 5-7 illustrate a second embodiment in which a resonator 142 is formed as a separate structure, which may be referred to as an insert, from the remainder of the housing 44. In FIGS. 5-7, the resonator 142 is configured as a cylindrical structure having an outer diameter 150 configured to fit in a recess 152 of the housing 44. In particular, the resonator 142 can be inserted along axis X into the recess 152. The resonator 142 can be held in place using known techniques, such as by using fasteners or by welding, or the resonator 142 could be held in place under the force of a pipe attached to the housing 44 adjacent the resonator 142. The resonator 142 exhibits a groove arrangement consistent with the embodiment of FIGS. 3-4.

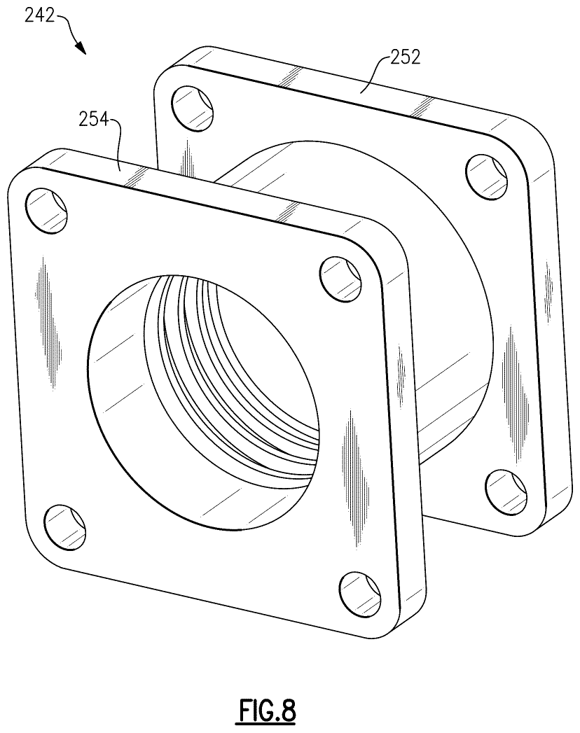

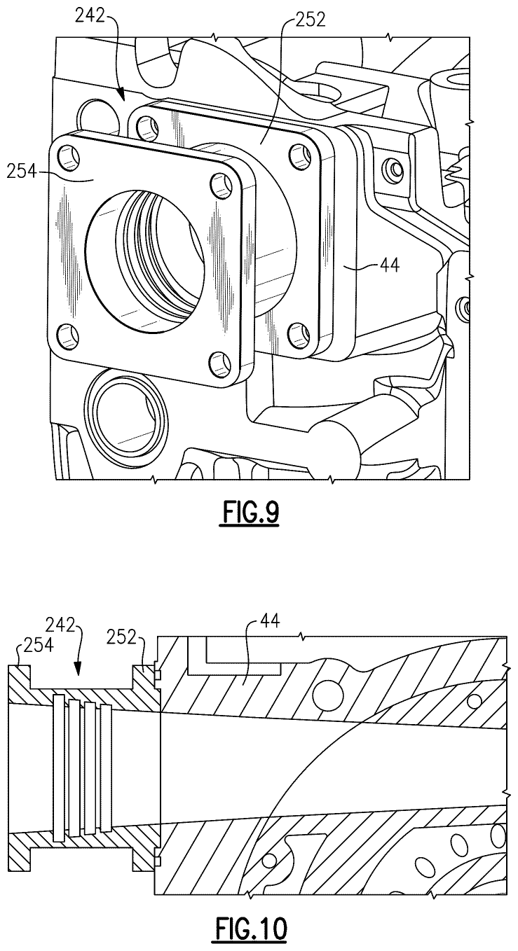

FIGS. 8-12 illustrate another embodiment of the resonator 242. In this example, the resonator 242 is also formed as a separate structure from the remainder of the housing 44. The resonator 242 includes a first plate 252 and a second plate 254 at opposite axial ends thereof. As shown in FIGS. 9 and 10, the first plate 252 could attach, such as by using fasteners, to the housing 44. A pipe leading to the condenser could attach to the second plate 254, again using fasteners. The resonator 242 exhibits a groove arrangement consistent with the embodiment of FIGS. 3-4.

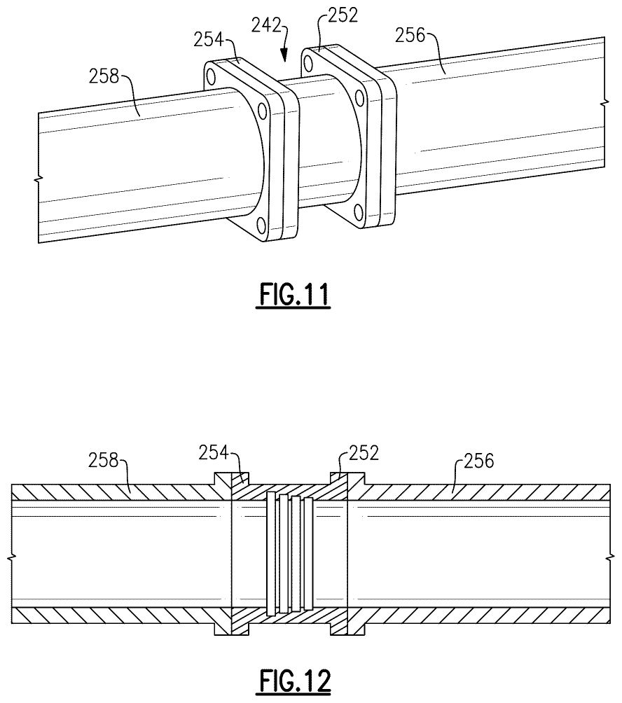

The resonator 242 does not need to be attached to the housing 44. As shown in FIGS. 11 and 12, the resonator 242 could be attached between a first pipe section 256 and a second pipe section 258. The first and second pipe sections 256, 258 could be sections of a pipe leading from the compressor 14 to the condenser 16. Instead of one of the first and second pipe sections 256, 258, the resonator 242 could attach to a valve, such as a check valve, for example.

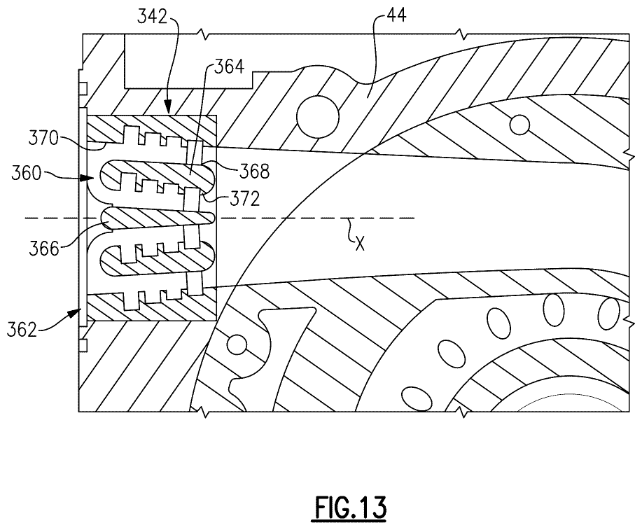

In another embodiment, as shown in FIG. 13, the resonator 342 could include an inner section 360, which is arranged radially inward of an outer section 362. In this example, the outer section 362 is configured substantially similar to the resonator 142, including grooves configured as in the embodiment of FIGS. 3-4.

The inner section 360 includes a ring 364 spaced-apart radially inward of the outer section 362, and a cone 366 spaced-apart radially inward of the ring 364. In particular, the radially outer surface 368 of the ring 364 is spaced-apart from the radially inner surface 370 of the outer section 362 such that fluid can flow between radially outer surface 368 and radially inner surface 370 to interface with the grooves of the outer section 362.

A radially inner surface 372 of the ring 364 is spaced-apart radially from the cone 366 such that fluid can flow between the cone 366 and the radially inner surface 372 to interface with grooves of the ring 364. In this example, the ring 364 includes grooves configured as in the embodiment of FIG. 3-4.

The cone 366 is not required in all examples. Further, a cone could be incorporated into the embodiments of FIGS. 3-12. The cone 366, if present, and the ring 364 may be supported by one or more radially projecting lugs, which project radially inward from radially inner surface 370.

Providing the inner section 360 with the same groove arrangement as the outer section 362 breaks up the fluid passing through resonator 342 into smaller volumes, which increases the likelihood and ability of fluid to interact with one or more of the grooves. In this regard, while one inner section with an additional, dedicated set of grooves is shown in FIG. 13, there could be additional inner sections, such as one or more sections radially inward of inner section 360, each with an additional, dedicated set of grooves configured as in the embodiment of FIGS. 3-4.

When present, the ring 364 and cone 366 exhibit curved leading and trailing edges. Further, a radial dimension of the cone 366 increases moving toward the outlet of the compressor 14, in this example.

Resonators 42, 142, 242, 342 discussed herein have like parts, including like groove arrangements, unless otherwise described.

Further, one or more of the resonators 42, 142, 242, 342 could be used together. For instance, the resonator 42 could be used in combination with resonator 242.

It should be understood that terms such as “axial,” “radial,” and “circumferential” are used above with reference to the normal operational attitude of the compressor 14. Further, these terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A refrigerant compressor, comprising:
a resonator configured to attenuate noise, wherein the resonator is arranged adjacent, or downstream of, an outlet of the refrigerant compressor.

2. The refrigerant compressor as recited in claim 1, wherein the resonator is integrally formed into a housing of the compressor.

3. The refrigerant compressor as recited in claim 1, wherein the resonator is located adjacent, or immediately downstream, of an outlet volute of the compressor.

4. The refrigerant compressor as recited in claim 1, wherein the resonator includes a plurality of grooves spaced-apart from one another along a central axis of a flow path radially inward of the plurality of grooves.

5. The refrigerant compressor as recited in claim 4, wherein the resonator includes an inner section arranged radially inward of an outer section.

6. The refrigerant compressor as recited in claim 5, wherein the plurality of grooves are formed in the outer section.

7. The refrigerant compressor as recited in claim 6, wherein the inner section includes a ring spaced-apart radially inward of the outer section, and wherein the inner section further includes a cone spaced-apart radially inward of the ring.

8. The refrigerant compressor as recited in claim 7, wherein a plurality of additional grooves are formed in a radially inner surface of the ring.

9. The refrigerant compressor as recited in claim 7, wherein a radial dimension of the cone increases moving toward the outlet of the refrigerant compressor.

10. The refrigerant compressor as recited in claim 4, wherein each of the plurality of grooves is rectangular in cross-sectional shape.

11. The refrigerant compressor as recited in claim 10, wherein each of the plurality of grooves exhibits a unique depth relative to the others of the plurality of grooves.

12. The refrigerant compressor as recited in claim 11, wherein each of the plurality of grooves exhibits an incrementally increasing depth moving toward the outlet of the refrigerant compressor.

13. The refrigerant compressor as recited in claim 12, wherein:
a first groove of the plurality of grooves a depth within a range of 2.5-3.5 mm and is configured to attenuate noise having a frequency of about 7,500 Hz,
a second groove of the plurality of grooves exhibits a depth within a range of 3.6-4.9 mm and is configured to attenuate noise having a frequency of about 6,000 Hz,
a third groove of the plurality of grooves exhibits a depth within a range of 5.0-6.5 mm and is configured to attenuate noise having a frequency of about 5,000 Hz, and
a fourth groove of the plurality of grooves exhibits a depth within a range of 6.6-8.5 mm and is configured to attenuate noise having a frequency of about 3,500 Hz.

14. The refrigerant compressor as recited in claim 1, wherein the resonator is formed as a separate structure from a housing of the refrigerant compressor, wherein the separate structure is configured to fit within a recess of the housing.

15. The refrigerant compressor as recited in claim 1, wherein:
the resonator is formed as a separate structure from a housing of the refrigerant compressor, and
the separate structure includes a plate configured to attach to a housing of the refrigerant compressor.

16. The refrigerant compressor as recited in claim 1, wherein:
the resonator is formed as a separate structure from a housing of the refrigerant compressor, and
the separate structure includes a plate configured to attach to a pipe downstream of the refrigerant compressor.

17. A refrigerant system, comprising:
a compressor, a condenser, an evaporator, and an expansion device, wherein the compressor comprises:
a resonator configured to attenuate noise, wherein the resonator is arranged adjacent, or downstream of, an outlet of the refrigerant compressor.

18. The refrigerant system as recited in claim 17, wherein the resonator includes a plurality of grooves spaced-apart from one another along a central axis of a flow path radially inward of the plurality of grooves.

19. The refrigerant system as recited in claim 18, wherein:
the resonator includes an inner section arranged radially inward of an outer section,
the plurality of grooves are formed in the outer section,
the inner section includes a ring spaced-apart radially inward of the outer section, and
the inner section further includes a cone spaced-apart radially inward of the ring.

20. The refrigerant system as recited in claim 18, wherein each of the plurality of grooves exhibits an incrementally increasing depth moving toward the outlet of the refrigerant compressor.
